(19) United States
(12) Patent Application Publication
(10) Pub. No.: US 2007/0271244 A1
(43) Pub. Date: Nov. 22, 2007

(54) Method of searching a specific computer IP address of internet networks using several specific telephone number with numbers in series which are arranged and assembled in sequence and coded with identification codes

(76) Inventor: Chung-Yu Lin, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/797,394

(22) Filed: May 3, 2007

Related U.S. Application Data
(60) Provisional application No. 60/798,319, filed on May 8, 2006.

(51) Int. Cl. G06F 17/30

(52) U.S. Cl. 707/3

(57) ABSTRACT

A method of searching a specific computer IP address of Internet networks using several specific telephone number with numbers in series which are arranged and assembled in sequence and coded with identification codes, comprising: a specific website, a searching interface program, a searching program, a first database and a second database; Wherein, The website server of said specific website is connected with the Internet; Said searching interface program, which is programmed in the applicable software language used in the World Wide Web, has a empty field for orderly entering the string mode of “country code+area code+local telephone number+identification code”; Said searching program, which is programmed in the applicable software language used in the World Wide Web, starts to perform the searching and matching comparison function upon the start request coming from the dynamic webpage of the searching interface; Said first database, which is configured in the website server of said specific website, has registered and stored with “index code for the IP address of each specific computer” and the corresponding information of telephone number with the identification code thereof; Said second database, which is also configured in the website server of said specific website, has registered and stored with “the IP address of each specific computer” and the corresponding information of said “index code for the IP address of each specific computer”. When any network client orderly keys in the string mode of “country code+area code+local telephone number+identification code” into the empty field on said searching interface program, said searching program will thereby start to perform the searching and matching comparison for all “index code for the IP address of each specific computer”; When matched information is successfully found, the program step will automatically go to said second database to perform the searching and matching comparison so as to find out the corresponding IP address of specific computer in conforming with said index code for the IP address of each specific computer; Thus, the network client can either successfully access and browse the website of certain specific domain name, or successfully send e-mail to the e-mail server of exclusive proprietary e-mail address for the recipient of certain person or company, or successfully communicate with the desired receiver for certain specific computer user over voice communication.

This application claims the benefit of provisional U.S. Patent Application No. 60/798,319, field May 8, 2006.

### FIELD OF THE PRESENT INVENTION

The present invention relates to an application technology in the field of computer network, more particularly to a method of searching database to aim at the patent application case submitted to the Taiwan Intellectual Property Office (TIPO) with Filing Number of 93112373 (namely U.S. Pat. No. of 11/116,248) in originating a new mechanism and method under the legal regulations of “The Protection Act of Personal Information in the Data Processing”.

### BACKGROUND OF THE INVENTION

The inventor of the present invention has submitted a patent application on Apr. 4, 2004 to the Taiwan Intellectual Property Office (TIPO) with Filing Number of 93112373 in title of “A method of searching a specific computer IP address of Internet networks using several specific telephone number with numbers in series which are arranged and assembled in sequence and coded with identification codes”, wherein, the feature is to combine the local telephone number, pertaining country code, pertaining area code and self-selected identification-code together so as to arrange which in specific permutation as the string mode of “country code+area code+local telephone number+identification code” and to collocate with exclusive proprietary specific domain name, or e-mail address, or mainframe IP address of the specific voice communication for simultaneously registering and storing on the server database in any specific website of the Internet. By way of the dynamic webpage of the searching interface on the specific website, after the orderly keying in the string mode of “country code+area code+local telephone number+identification code” pertaining to certain person or company, the searching program of the specific website server will start to perform the searching and matching comparison so as to find out the corresponding exclusive proprietary specific domain name, or e-mail address or mainframe IP address of specific voice communication in conforming with said string mode thereof so that the network client is either automatically connected to the website of certain exclusive proprietary specific domain name, or e-mail address or mainframe IP address of specific voice communication; Thus, the network client can either successfully access and browse the website of certain specific domain name, or successfully send e-mail to the e-mail server of exclusive proprietary e-mail address for the recipient of certain person or company, or successfully enable the desired receiver of certain person or company to ascertain the Voice Message Request from the caller over on-line voice communication software immediately so that the mutual voice communication between the caller and receiver can be successfully accomplished by virtue of the Internet in low communication cost rate. As to the content of the prior art already disclosed in other specifications thereof, it will be unnecessary to give detailed description here.

Moreover, the inventor of the present invention set up the www.2uDG.com website to practically implement the operation in accordance with the method disclosed in the present invention so far, since he submitted aforesaid invention patent application, and resulting in achievement of successful effect as expected function. However, for complying with the legal regulations of “The Protection Act of Personal Information in the Data Processing”, all the database providers of the current business will add various “index code” without consulting anyone to protect all the registered entries of e-mail server IP address, or website server IP address, or voice communication mainframe IP address pertaining to personal or corporate private information so as to prevent form leaking personal information of name, birthday and the ID number for further avoiding from being sued in a court of law in consequence of violating “The Protection Act of Personal Information in the Data Processing”.

### SUMMARY OF THE INVENTION

A main object of the present invention is to provide a “method of searching a specific computer IP address of Internet networks using several specific telephone number with numbers in series which are arranged and assembled in sequence and coded with identification codes”, comprising: a specific website, a searching interface program, a searching program, a first database and a second database. Wherein, the website server of said specific website is connected with the Internet; Said searching interface program, which is programmed in the applicable software language used in the World Wide Web, has a empty field for orderly entering the string mode of “country code+area code+local telephone number+identification code”; Said searching program, which is programmed in the applicable software language used in the World Wide Web, starts to perform the searching and matching comparison function upon the start request coming from the dynamic webpage of the searching interface; Said first database, which is configured in the website server of said specific website, has registered and stored with “index code for the IP address of each specific computer” and the corresponding information of telephone number with the identification code thereof; Said second database, which is also configured in the website server of said specific website, has registered and stored with “the IP address of each specific computer” and the corresponding information of said “index code for the IP address of each specific computer”.

When any network client orderly keys in the string mode of “country code+area code+local telephone number+identification code” into the empty field on said searching interface program, said searching program will thereby start to perform the searching and matching comparison for all “index code for the IP address of each specific computer”; When matched information is successfully found, the program step will automatically go to said second database to perform the searching and matching comparison so as to find out the corresponding IP address of specific computer in conforming with said index code for the IP address of each specific computer; Thus, the network client can either successfully access and browse the website of certain specific domain name, or successfully send e-mail to the e-mail server of exclusive proprietary e-mail address for the recipient of certain person or company, or successfully communicate with the desired receiver for certain specific computer user over voice communication.

### BRIEF DESCRIPTION OF THE DRAWINGS

FIG. 1 is the flowchart illustrative view of the first preferred embodiment in the present invention.

FIG. 2 is the flowchart illustrative view of the second preferred embodiment in the present invention.

FIG. 3 is the flowchart illustrative view of the third preferred embodiment in the present invention.

### DETAILED DESCRIPTION OF THE PREFERRED EMBODIMENTS

As to the other objects and features, it will be detailed described in the following concrete exemplary embodiments in association with the accompanying drawings:

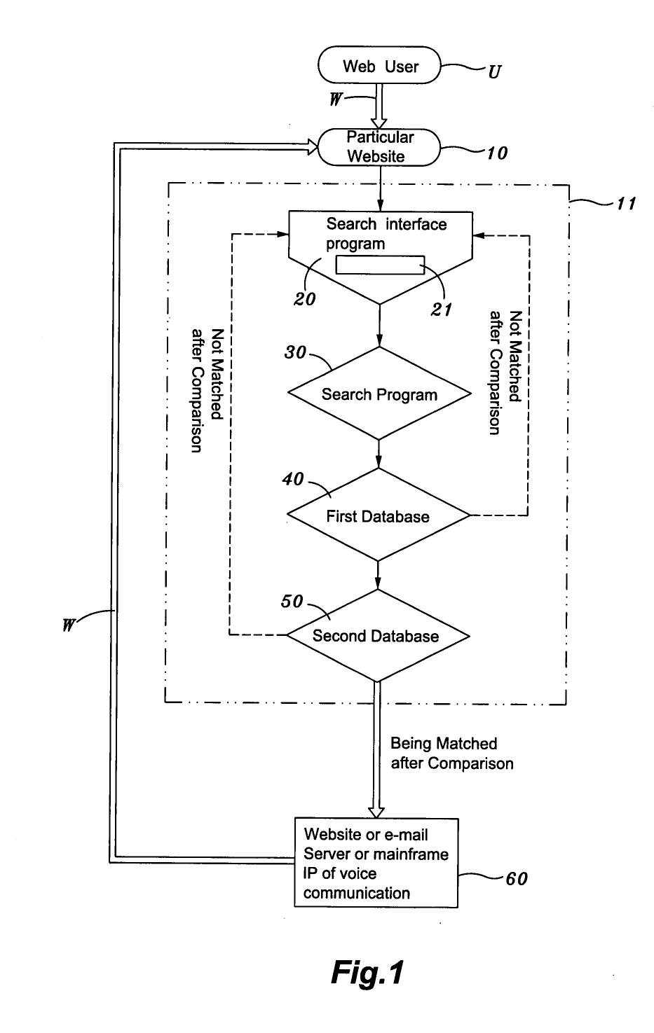

Please refer to the FIG. 1, which is the flowchart illustrative view of the first preferred embodiment in the present invention of “method of searching a specific computer IP address of Internet networks using several specific telephone number with numbers in series which are arranged and assembled in sequence and coded with identification codes”, comprising: a specific website 10, a searching interface program 20, a searching program 30, a first database 40 and a second database 50; Wherein, Said specific website 10, whose specific website server 11 being connected with the Internet W, has data format of output and input information conforming to all the protocols on the Internet W; Said searching interface program 20, which is programmed in the applicable software language used in the Internet W, has a empty field 21 for orderly entering the string mode of “country code+area code+local telephone number+identification code”; Said searching program 30, which is programmed in the applicable software language used in the Internet W, starts to perform the searching and matching comparison function upon the network client U keying in the string mode of “country code+area code+local telephone number+identification code” into the empty field 21 on said searching interface program 20 of said specific website 10; Said first database 40, which is configured in the specific website server 11 of said specific website 10, has registered and stored with “index code for the IP address of each specific computer” and the corresponding information of telephone number with the identification code thereof; Said second database 50, which is also configured in the specific website server 11 of said specific website 10, has registered and stored with “the IP address of each specific computer” and the corresponding information of said “index code for the IP address of each specific computer”.

Both of aforesaid searching interface program 20 and searching program 30 can be programmed in the applicable software language used in the Internet W, with execution capability of expected searching and matching comparison function, which is the well-known public open technology for the professional experts skilled in such software language, deserving to be declared here.

Further referring to the FIG. 1, when the network client U already knew the exclusive proprietary telephone number or cellular phone number with identification code of the domain name or e-mail address or mainframe IP address of specific voice communication pertaining to some specific person or company, he first accesses the specific website 10 via the Internet W and clicks for entering the searching interface program 20 of said specific website 10, by virtue of aforesaid known exclusive proprietary telephone number or cellular phone number with identification code, he then orderly keys in the string mode of “country code+area code+local telephone number+identification code” into the empty field 21 on said searching interface program 20, for example “886+7+1234567+john007” or ““886+1234567890+john007” to correspond with “Taiwan country code+Kao-Hsiung area code+local telephone number+identification code” or “Taiwan country code+personal cellular phone number+identification code”; Said searching interface program 20 will thereby execute the program command and immediately activate said searching program 30, so that said searching program 30 will perform the searching and matching comparison for all “index code for the IP address of each specific computer” and corresponding information of the telephone number with identification code thereof in the first database 40; When matched information is successfully found for corresponding “index code for the IP address of specific computer”, the program step will automatically go to said second database 50 to perform the searching and matching comparison; If the corresponding IP address of specific computer in conforming with said index code for the IP address of specific computer is found, the mainframe 60 for anyone of website, email server or voice communication corresponding to said IP address of specific computer will be immediately connected automatically so as to let the network client U either successfully access and browse the website of certain specific domain name or successfully send e-mail to the e-mail server of exclusive proprietary e-mail address for the recipient of certain person or company, or successfully communicate with the desired receiver for certain specific computer user over voice communication; Conversely, after the execution of said searching program 30, if the corresponding string of telephone number with identification code in conforming with said index code for the IP address of specific computer is not found, a command of “please re-enter the correct telephone number and identification code” will be immediately sent out to said searching interface program 20 to inform the network client U that he must key in the correct telephone number and identification code again into the empty field 21 of said searching interface program 20 for another searching and matching comparison.

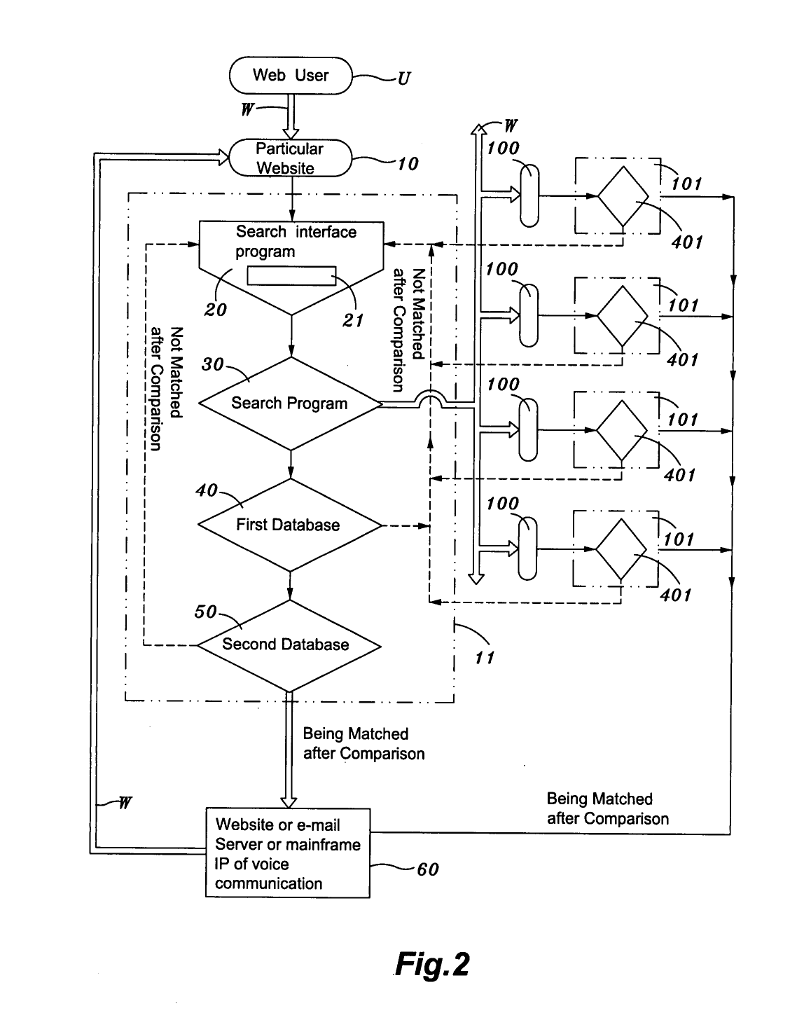

Please refer to the FIG. 2, which is the second preferred embodiment of the present invention, wherein the first database 40 is not only configured in the specific website server 11 of the specific website 10 but also includes some databases 401 being configured in each website server 101 of any website 100, which is connected on the Internet W respectively so that each of said databases 401 has registered and stored with “index code for the IP address of each specific computer” and the corresponding information of telephone number with the identification code thereof;

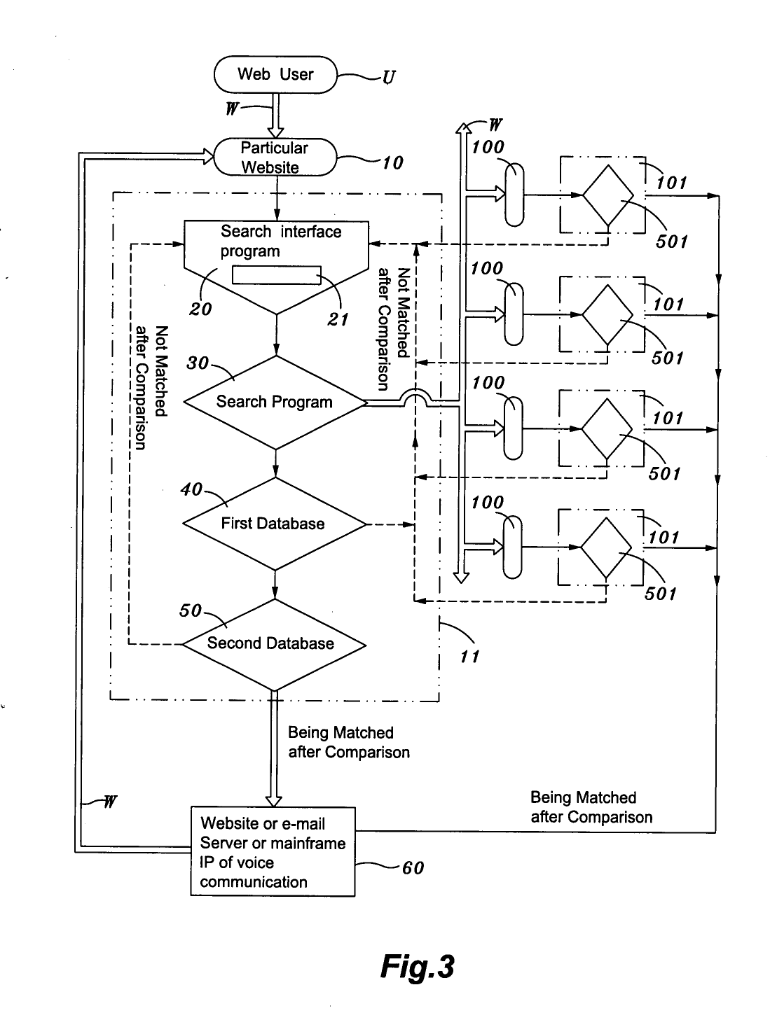

Please refer to the FIG. 3, which is the third preferred embodiment of the present invention, wherein the second database 50 is not only configured in the specific website server 11 of the specific website 10 but also includes some databases 501 being configured in each website server 101 of any website 100, which is connected on the Internet W respectively so that each of said databases 501 has registered and stored with “the IP address of each specific computer” and the corresponding information of said “index code for the IP address of each specific computer”.

The “identification code” mentioned in the above first preferred embodiment through third preferred embodiment consists of at least any two of the character, number or symbol so that it can immediately change even being cracked by any chance; thus, it really has industrial applicability and practicality.

What is claimed is:

1. A method of searching a specific computer IP address of Internet networks using several specific telephone number with numbers in series which are arranged and assembled in sequence and coded with identification codes, comprising:
A specific website, whose website server being connected with the World Wide Web or the Internet, has data format of output and input information conforming to all the protocols on the World Wide Web or the Internet;
A searching interface program, which is programmed in the applicable software language used in the World Wide Web or the Internet, has a empty field for orderly entering the string mode of “country code+area code+local telephone number+identification code”;
A searching program, which is programmed in the applicable software language used in the World Wide Web or the Internet, starts to perform the searching and matching comparison function upon the network client keying in the string mode of “country code+area code+local telephone number+identification code” into the empty field on said searching interface program of said specific website; and
A first database and a second database, both of which are configured in the server of said specific website, wherein, said first database has registered and stored with index code for the IP address of each specific computer and the corresponding information of telephone number with the identification code thereof; and said second database has registered and stored with the IP address of each specific computer and the corresponding information of said index code for the IP address of each specific computer.

2. The “method of searching a specific computer IP address of Internet networks using several specific telephone number with numbers in series which are arranged and assembled in sequence and coded with identification codes” as recited in the claim 1, wherein said first database further comprises some databases being configured in each website server of any website, which is connected on the World Wide Web or the Internet respectively so that each of said databases has registered and stored with “index code for the IP address of each specific computer” and the corresponding information of telephone number with the identification code thereof.

3. The “method of searching a specific computer IP address of Internet networks using several specific telephone number with numbers in series which are arranged and assembled in sequence and coded with identification codes” as recited in the claim 1, wherein said second database further comprises some databases being configured in each website server of any website, which is connected on the World Wide Web or the Internet respectively so that each of said databases has registered and stored with “the IP address of each specific computer” and the corresponding information of said “index code for the IP address of each specific computer”.

4. The “method of searching a specific computer IP address of Internet networks using several specific telephone number with numbers in series which are arranged and assembled in sequence and coded with identification codes” as recited in the claim 1, wherein the string mode of “country code+area code+local telephone number+identification code” of said searching interface program is further set as the string mode of “country code+cellular phone number+identification code”.
